(19) United States
(12) Patent Application Publication
(10) Pub. No.: US 2015/0248211 A1
(43) Pub. Date: Sep. 3, 2015

(54) METHOD FOR INSTANTANEOUS VIEW-BASED DISPLAY AND SELECTION OF OBSCURED ELEMENTS OF OBJECT MODELS

(71) Applicant: Nemetschek Vectorworks, Inc., Columbia, MD (US)

(72) Inventors: Steve Johnson, Catonsville, MD (US); Joshua Loy, Sykesville, MD (US); John Kerr, Savage, MD (US); Hernan Stamati, Bethesda, MD (US); Justin Hutchison, Columbia, MD (US); Daniel Abretske, Baltimore, MD (US)

(73) Assignee: Nemetschek Vectorworks, Inc., Columbia, MD (US)

(21) Appl. No.: 14/193,468

(22) Filed: Feb. 28, 2014

(51) Int. Cl. G06F 3/0481; G06F 3/0484

(52) U.S. Cl. CPC G06F 3/04815; G06F 3/04812; G06F 3/04842

(57) ABSTRACT

A new hybrid method for displaying, detecting, and selecting objects in a CAD system is disclosed. A CAD model is loaded and displayed using one of several render techniques to approximate natural visual perception (e.g. hidden-line rendering, solid rendering or 3D textured rendering). These render techniques necessarily hide parts of the model to approximate natural vision; additionally, only objects visible to the rendered presentation may be detected (as geometry “snapped to” for additional constructions) or selected for editing.

The hybrid presentation method provides in any editing context an instantly available “x-ray view” that apparently de-renders the model in a region surrounding the point of interest and makes any part of the model at any depth visible within the region available for detection, selection or editing. In this mode objects are selectable not by their faces, but by their edges, which are more easily distinguished and picked in this view.

### BACKGROUND

Embodiments of the invention relate to the fields of computer-aided design (CAD), building-information modeling, facility management, architectural and engineering design, and visualization.

A paradox of modern computer-aided design, especially when applied to large and very complex object-models such as modern buildings, is that the rendering methods that make navigation through and around the models visually comprehensible (which may include solid rendering, hidden line rendering, or ray-trace rendering) also hide many important parts of the model. For example, the CAD user wishes to see and edit some objects (e.g. pipes or conduits within walls, anchor bolts) only in certain contexts, the rest of they time they clutter up the user's visual experience and ability to discern, select elements within, and edit the model.

Certain techniques that are well-known to those skilled in the techniques of computer-aided design, for example “clipping view planes” or “clipping cubes”, exist to eliminate portions of the model from view and to allow the user to see and manipulate his objects of interest. Other techniques involve specially invoked on-screen controls such as “transparency lenses” or special object picking modes to cause objects to become transparent or provisionally invisible, to identify some objects (or parts of objects) as “important” or “non-important”, or to provide on-screen lists of candidate selectable objects. These techniques all suffer from the drawback of forcing the user to interrupt his workflow to invoke a new set of on-screen controls or a new picking mode, or otherwise create a new context for editing.

A need exists to complement the “intuitive and natural” ability to view, navigate, select and manipulate only elements in the user's immediate range of vision with the ability to instantaneously (and without interrupting his current operational mode or work-flow) “drill down” in detail to see and edit everything that is within a certain limited visual point-of-interest, so that he may explore the model in depth, construct new model elements based on the locations of existing obscured model geometry, or select and edit obscured elements of the model.

### SUMMARY

Disclosed embodiments include a hybrid method for displaying, detecting (for snapping and geometric construction purposes) and selecting objects in a CAD system. The method may include:

Loading a graphic model with a plurality of model elements (which are comprised of hierarchical object-groupings of 3D geometric edges and faces) in a hardware-based CAD system; rendering the model elements in a realistic visual manner using “hidden line”, “solid rendering”, or “ray-traced rendering”; and making only visible objects detectable (for snapping and construction) and selectable (for editing operations) using face-based selection. This “standard view” is produced with standard techniques, familiar to those skilled in the art of three dimensional computer-aided design

Providing to the user an alternate “hybrid view” that is fully rendered, except in a region surrounding and tracking the current location of the system cursor, which is unrendered (shown in “wireframe” view). In this mode, all objects in the complete depth of the model are detectable (for snapping and construction) and selectable (for editing operations) using edge-based selection;

Allowing instantaneous user switching between the two views in a manner that does not interrupt the user's context, action or workflow in any way.

The previously described method thus allows both realistic model viewing and manipulation and instantly accessible detailed and in-depth model viewing and manipulation, with no interruption of the user's working mode.

### DESCRIPTION OF THE DRAWINGS

FIG. 1 is a diagram of a computer system.

FIG. 2 is an illustration of a model in perspective view, as might be shown in a window on a computer display.

FIG. 3 is an illustration in top view of the same model as in FIG. 2.

FIG. 4 is an illustration of a model showing how elements are highlighted when selected according to an exemplary embodiment of the invention.

FIG. 5 shows the hybrid display and selecting mode as applied to the same model in FIG. 6 according to an exemplary embodiment of the invention.

FIG. 7 shows the hybrid display and selecting mode and points of click-selection on the model according to an exemplary embodiment of the invention.

FIG. 8 shows the primary display and selecting mode with otherwise invisible objects selected according to an exemplary embodiment of the invention.

FIG. 9 shows a hidden-line display wherein a user is trying to place an object on a working plane according to an exemplary embodiment of the invention.

FIG. 10 shows a hidden-line display with the hybrid display and selecting mode activated according to an exemplary embodiment of the invention.

FIG. 11 shows a diagram of the program logic used to create the instantaneous switching between object highlighting and picking modes according to an exemplary embodiment of the invention.

### DETAILED DESCRIPTION

Embodiments of the present invention facilitate the viewing, geometric detection (as for “snapping” to dimensionally control the creation of new geometry), and selection of 3D model objects that are obscured by other 3D model objects in a visually realistic rendering, such as solid rendering, hidden line rendering, or ray-trace rendering. A 3D CAD system employing embodiments of the present invention enables an engineer or designer to instantaneously, and without interrupting his current operation or requiring the use of a new tool, explore, snap to, and/or select objects that are otherwise obscured in the rendered (realistically presented) model.

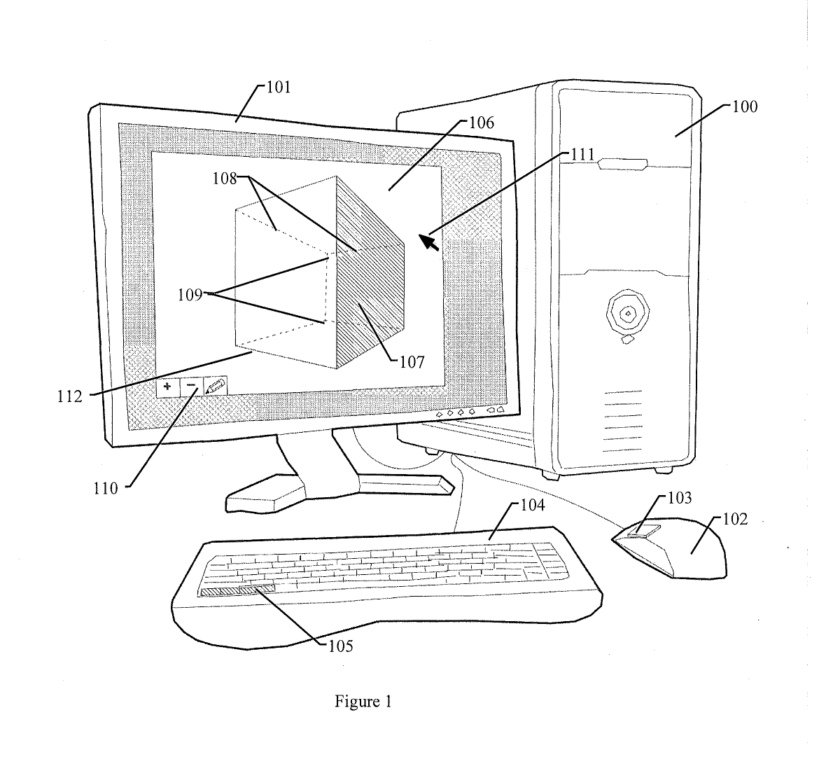

FIG. 1 shows a computer-aided-design (CAD) system comprising generally a processing and data-storage unit 100, a graphical display 101, a keyboard 104, and a pointing device 102 with an actuator button 103. The pointing device 102 (in this particular example a “mouse” style device) controls an on-screen pointer or “cursor” 111. The cursor 111 may be used to point at and (using the actuator button 103) click to select on-screen objects 112 or activate on-screen “tools” 110 which put the CAD program into one of a variety of states or modes.

For example, in one such mode, a click on an on-screen object may select it. In another mode, a click might delete the object. In a third, a click may duplicate the object or edit it in a certain way. It is relevant to note that to change the state or mode of the CAD system, the user must interrupt what he is doing to click on an on-screen tool 110. For the engineer or designer's productivity, it is desirable to minimize these interruptions.

On-screen objects 112 may be displayed in “rendered” mode, herein used to mean “a natural visual presentation using solid, hidden-line, ray-trace, or other form of 3D rendering.” In such a rendered mode, their visible faces 107 are wholly or partially displayed as the scene and the user's point-of-view warrant, and their hidden edges 108 and hidden points or vertices 109 are concealed. This creates a natural and easily comprehensible viewing environment, but can require many view manipulations to observe hidden points 109 or edges 108 when they need to be shown or otherwise accessed (as for, say, dimensional control or “snapping”). This concept of hiding may be obviously extended to entire hidden objects, and not just parts of objects, such as edges or points.

Certain keys 105 on the keyboard 104 may be assigned by the CAD program for certain controlling functions in addition to their standard text-entry function. For example, when a certain key is depressed, the CAD program's snapping mode may instantly be altered or suspended. Releasing the key immediately restores the earlier state. This may be referred to as “snap-back key” functionality.

Although the example computer system described and illustrated incorporates a “mouse” type pointing device 102, and describes keys 105 as the actuators of modal change, other pointing devices (e.g. trackballs, light pen styluses, or touch-screens) and actuators (e.g. additional mouse buttons, track pad gestures) may be incorporated as reasonable alternatives to achieve the same results. Their specific embodiment as described herein is not central to the functionality of embodiments of invention, and simple alternatives may easily be envisioned.

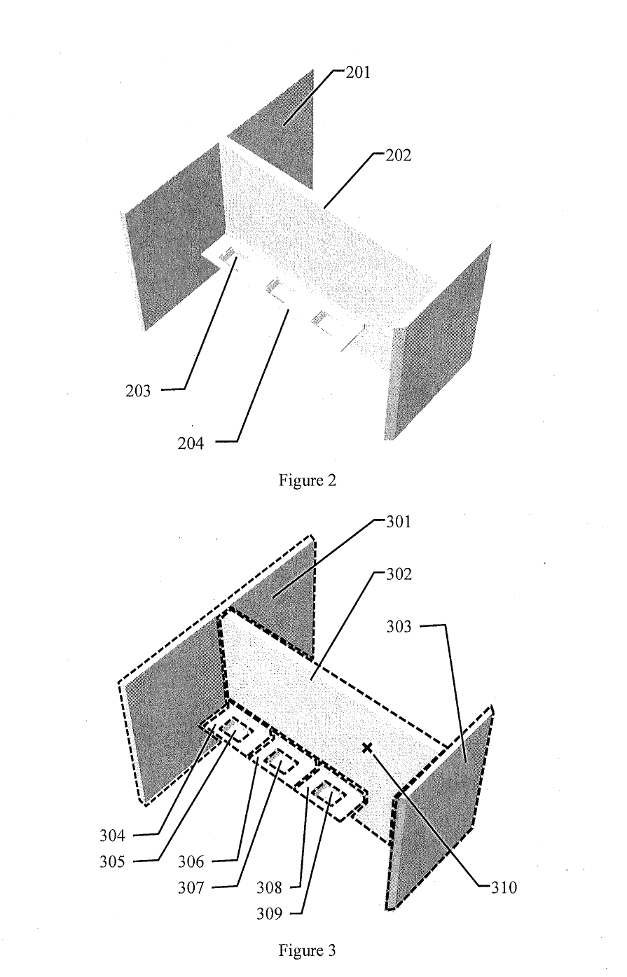

FIG. 2 shows a solid rendering of a simple arrangement of walls 201 of which one wall 202 is a plumbing wall (a wall containing piping). Visible also are wall hung sinks 203 (quantity 3) and wall hung countertop units 204 in which the sinks are mounted. In total, 3 walls, 3 sinks, and 3 countertop units are visible. This display method is the primary method of an embodiment of the invention; objects are displayed in a rendered, easy-to-understand style, and only visible objects may be selected or snapped to.

FIG. 3 is a reiteration of FIG. 2 overlaid with Selection Regions 301, 302, 303, 304, 305, 306, 307, 308, and 309 (all represented in the figure by dashed-line boundaries). Each of these boundaries when clicked with the cursor 111 will cause the underlying object to become selected. A click point 310 is shown for illustration. If the user clicks at this point, the wall underlying the selection region 302 becomes selected and highlighted.

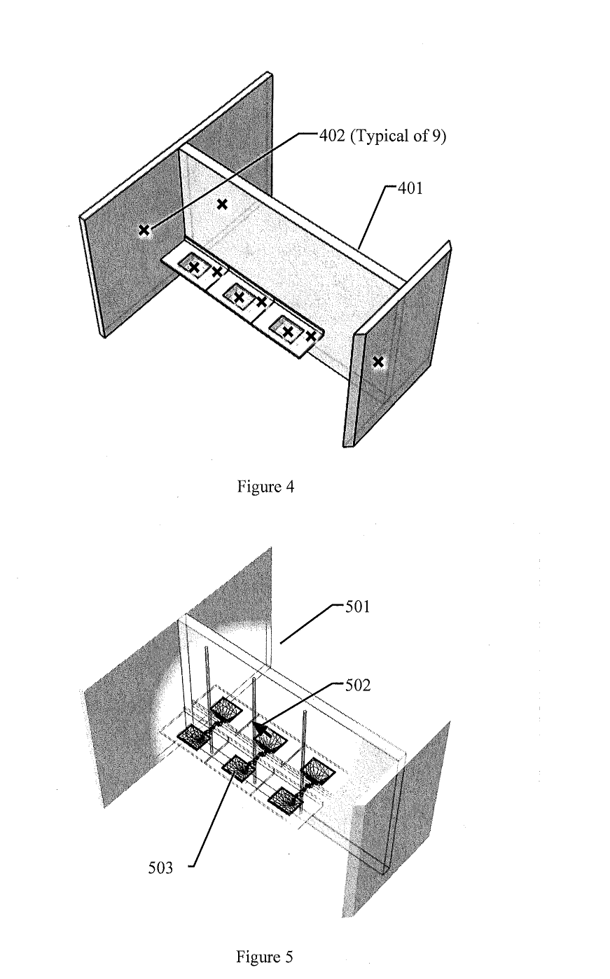

FIG. 4 shows the same view again, this time with all the visible and pickable objects 401 selected. Everything that can be picked has been, and the picked objects are shown with heavy outlines to indicate their selected state. The click points 402 (typical) show where the display was clicked to select the objects. Note that in all but one of the click points, more than one object lies beneath the click point and that the click selects the nearest object, the one that would “touched” if the model were physical rather than computer generated.

FIG. 5 shows the hybrid display, detection, and selection method of an embodiment of the invention. In an “X-ray” region 501 surrounding the active cursor position 502, all visible as well as normally hidden objects 503 have been displayed in an unrendered “wire-frame” display. Additionally, the picking mode of the cursor has been altered to allow it to pick not by faces as in FIG. 3 and FIG. 4, but by edges that are revealed in the wire-frame display. This allows a user to pick any object at any depth in the model, whether it is visible in the rendered view of the primary display method or not.

FIG. 6 shows the hybrid display, detection, and selection method of this invention being used to click in the drawing at six locations 601. The Shift key of the keyboard 104 may be depressed to allow selecting of multiple objects.

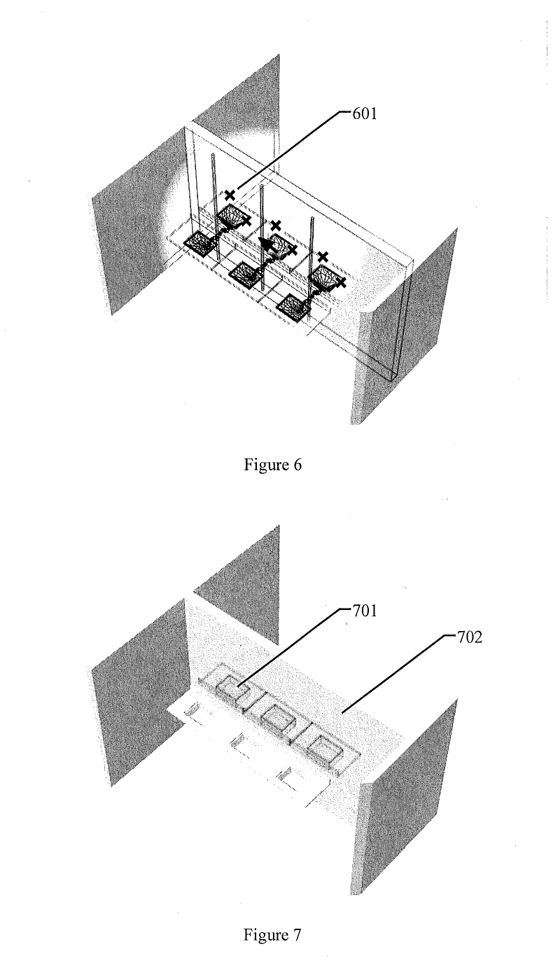

FIG. 7 shows the result of the six clicks in FIG. 6. The primary display, detection, and selection method of this invention has been restored by releasing the snap-back key 105 that invokes the hybrid mode. The six objects selected 701 are highlighted and show through the solidly rendered wall 702, such that they can now be edited by the user.

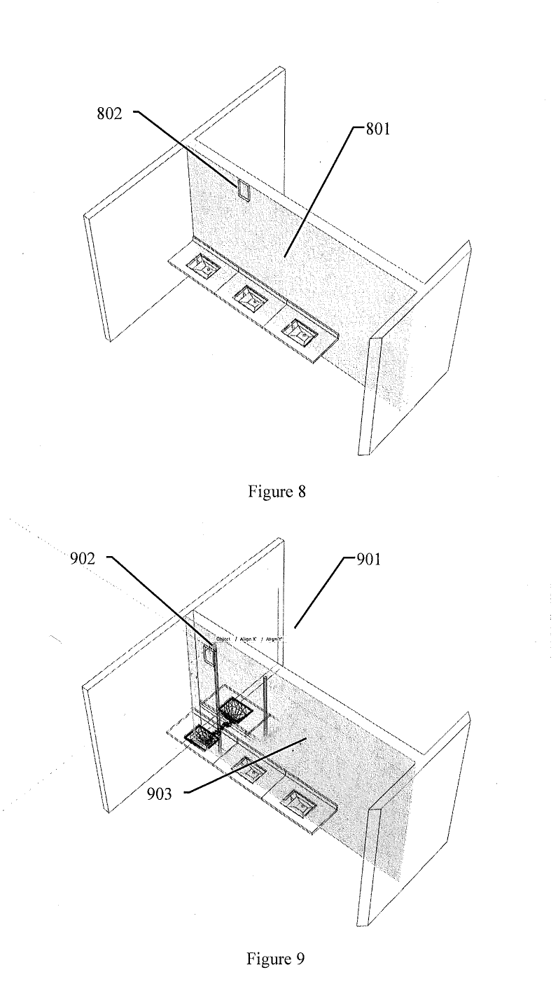

FIG. 8 shows the same model in “hidden line render” in the primary display, detection, and selection method. The user is trying to place an access hatch object 802 on the near face of the wall which has been highlighted as a working plane 801. The user's intent is to center the access hatch 802 over a pipe that is hidden in the wall. The user presses a specific snap-back key to invoke the hybrid display, detection, and selection method as illustrated in FIG. 9. Instantaneously, within the “X-ray” region 901 all the hidden objects are made visible and detectable for the purposes of snapping. The user can easily reference a snapping point 902 and place the access hatch object 802 in its proper location on the still-active working plane 903.

The use of a snap-back key 105 (rather than some other non-screen method) and the user of a mouse like pointing device 102 (as opposed to a trackball or other pointing method) are not essential to the functionality of this invention. Accordingly, other specific embodiments are within the scope of the following claims.

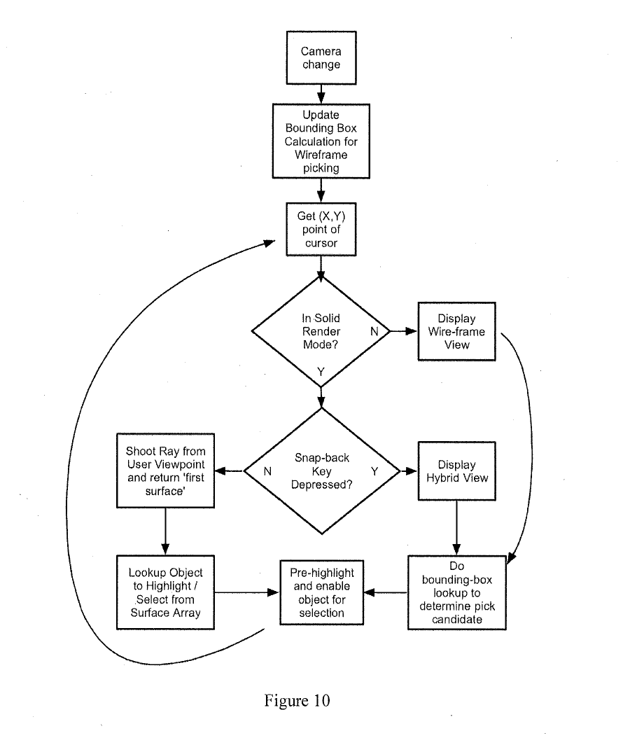

FIG. 10 shows the program logic that may be used to achieve the instantaneous switch in the object detection and selection methods. Two simultaneous object models are continuously maintained in the method, one based on 2D bounding-box projection onto the computer display 106 and one based on the 3D geometry contained in the scene and controlled by an industry-standard 3D graphics engine. With every change in camera view, the bounding box projections of all on-screen objects are recalculated and cached for rapid picking using the edge-based method in “wireframe” display. Simultaneously, a ray-casting algorithm is employed for accurate face-based picking in “solid” display. Continuous maintenance of both object detection and selection methods combined with a graphics-hardware generated “X-ray view” 501, 901 allows instantaneous user switching between the user modes.

What is claimed is:

1. A method for displaying and selecting geometric objects in a three-dimensional computer-generated model, the method comprising:
displaying the three-dimensional computer-generated model on a graphical display;
rendering the three-dimensional computer-generated model in a realistic manner such that certain elements of the model closer to the 3D viewpoint of an operator obscure other elements of the model further away from the 3D viewpoint of the operator;
allowing only objects that are completely or partially visible from the viewpoint of the operator to be selectable;
allowing only objects that are completely or partially visible from the viewpoint of the operator to be editable, by the use of one of a variety of specific editing tools operating with or without an object selected or editing commands operating on selected objects only;
allowing only objects that are completely or partially visible from the viewpoint of the operator to be snappable;

2. The computer-implemented method of claim 1, wherein model elements are highlighted or selected by pointing to and picking their faces using a cursor which unambiguously identifies the object to be selected;

3. A hybrid method for displaying and selecting geometric objects in a three-dimensional computer-generated model, the method comprising:
rendering the three-dimensional computer-generated model in a realistic manner such that certain elements of the model closer to the 3D viewpoint of an operator obscure other elements of the model further away from the 3D viewpoint of the operator;
presenting, only in a region surrounding the current cursor position, the three-dimensional computer-generated model in a non-rendered “wireframe” manner such that no elements of the model are obscured;
moving the region of the hybrid display method as the cursor is moved;
allowing any object in the entire depth of the model to be selectable, by one of a variety of specific selection methods;
allowing any object in the entire depth of the model to be editable, by the use of one of a variety of specific editing tools operating with or without an object selected or editing commands operating on selected objects only;
allowing any object in the entire depth of the model to be snappable;

4. The computer-implemented method of claim 3, in which model elements are highlighted or selected by pointing to and picking their edges using the cursor, which allows for easy discrimination and selection of objects that may be overlapping in depth;

5. The computer-implemented method of claim 3, in which only in a region surrounding the cursor and not the entire display is alternately displayed, provides spatial orientation and context so that the user may make better judgments about object extents, features, and positions while in that mode.

6. A method of invoking the alternate mode described in claim 3 using a “snap-back key” (or other method which may be invoked without cursor pointing or clicking on-screen), making the mode instantly available.

7. The computer-implemented method of claim 6, in which the invocation method requires no special on-screen tools or picking, allows the user to continue without interruption whatever action he is doing in his chosen program mode or tool.

8. The computer-implemented method of claim 6, in which the invocation method may be instantaneously released or canceled, allowing the user to return to the realistic rendering method of claim 1, for continued model exploration, viewing, and evaluation.

9. The computer-implemented method of claim 6, wherein the instantaneous switching between the two user display-, detection-, and selection modes is enabled by the continuous maintenance of two separate algorithms, one screen-based for the edge- picking method and one spatially-based for the face-picking method.

10. The computer-implemented method of claim 6 wherein the objects are comprised of hierarchical groups of 3 dimensional edges and faces.

11. The computer-implemented method of claim 6 wherein snappable includes geometrically referable to constrain new geometry entry points.
